(19) United States
(12) Patent Application Publication
(10) Pub. No.: US 2024/0213691 A1
(43) Pub. Date: Jun. 27, 2024

(54) CONNECTOR AND TERMINAL CONNECTION METHOD

(71) Applicant: YAZAKI CORPORATION, Tokyo (JP)

(72) Inventors: Kei Yamamura, Makinohara-shi (JP); Noboru Hayasaka, Makinohara-shi (JP); Jun Sugioka, Makinohara-shi (JP); Kento Komon, Makinohara-shi (JP); Tomohiro Ishihara, Makinohara-shi (JP)

(21) Appl. No.: 18/600,461

(22) Filed: Mar. 8, 2024

Related U.S. Application Data
(63) Continuation of application No. PCT/JP2022/044921, filed on Dec. 6, 2022.

(30) Foreign Application Priority Data
Jan. 11, 2022 (JP) 2022-002023

(51) Int. Cl. H01R 4/18; H01R 4/12; H01R 13/6581

(52) U.S. Cl. CPC H01R 4/185; H01R 4/12; H01R 13/6581

(57) ABSTRACT

The present disclosure provides a connector and a terminal connection method that enable a terminal to be connected to the connection conductor in an arbitrary rotation position. A connection conductor includes a braided wire that has been braided in a tubular shape, and a conductor that has been inserted into the braided wire, and has a columnar shape or a cylindrical shape, and the braided wire and the conductor constitute an end that is to be joined to a terminal. The conductor is, for example, a stranded wire having a columnar shape, and extends from one end to another end of the braided wire.

### CROSS-REFERENCE TO RELATED APPLICATION(S)

This application is a continuation application of International Application No. PCT/JP2022/044921 filed on Dec. 6, 2022 which claims the benefit of priority from Japanese Patent Application No. 2022-002023 filed on Jan. 11, 2022 and designating the U.S., the entire contents of which are incorporated herein by reference.

### BACKGROUND OF THE INVENTION

### 1. Field of the Invention

The present invention relates to a connector and a terminal connection method.

### 2. Description of the Related Art

Conventionally, a technique for connecting terminals by using a connection conductor has been proposed. Japanese Patent Application Laid-open No. 2015-082466 A discloses a connector that includes an equipment-side terminal that is fitted and connected to a counterpart terminal, an electric-wire-side terminal that is connected to a terminal of an electric wire, and is fixed to a housing, and a connection conductor that is connected between the equipment-side terminal and the electric-wire-side terminal, and can be extended or shortened in an axial direction. The connector of Japanese Patent Application Laid-open No. 2015-082466 A employs, as the connection conductor, a braided wire in a form where a swelling portion is provided in a central portion in a length direction.

In a case where the connection conductor is a flexible braided wire, a shape of the connection conductor is a flat shape. Therefore, in joining a terminal to the connection conductor, a rotation position of the terminal relative to the axial direction of the connection conductor is restricted by the flat shape of the connection conductor. As a result of this, it is difficult to freely set an orientation of the terminal, and this results in an increase in size of an apparatus in some cases. For example, in a case where two terminals are connected by using the connection conductor inside the connector, if an orientation of the connection conductor is restricted, the connector is likely to increase in size.

It is preferable that the terminal can be positioned in an arbitrary rotation position relative to the connection conductor, and the terminal can be joined to the connection conductor.

### SUMMARY OF THE INVENTION

It is an object of the present invention to provide a connector and a terminal connection method that enable a terminal to be connected to the connection conductor in an arbitrary rotation position.

In order to achieve the above mentioned object, a connector according to one aspect of the present invention includes connection conductors that include a braided wire that has been braided in a tubular shape, and a conductor that has been inserted into the braided wire, and extend in the first direction; first terminals that have been joined to a first end of each of the connection conductors, and include connection portion connected to a counterpart terminal; second terminals that have been joined to a second end of each of the connection conductors, and connected to electric wires; and a housing that retains the first terminals and second terminals, wherein two of the connection conductors are arranged in a second direction that is orthogonal to the first direction, two of the first terminals are arranged in the second direction, and two of the second terminals are arranged in the second direction, the conductor extends from the first end to the second end, in the conductor, a portion between the first end and the second end has a columnar shape or a cylindrical shape, and a rotation position of the first terminal and the rotation position of the second terminal relative to an axial direction of the connection conductor are different from each other in such a way that an interval between the connection portions in the second direction relative to an interval between the electric wires in the second direction is small.

In order to achieve the above mentioned object, a terminal connection method according to another aspect of the present invention includes a process of joining a first terminal to a first end of a connection conductor; and a process of joining a second terminal to a second end of the connection conductor, wherein the first end and the second end before joining include a braided wire that has been braided in a tubular shape and a conductor that has been inserted into the braided wire, the conductor having a columnar shape or a cylindrical shape, and the first terminal and the second terminal are joined to the connection conductor in rotation positions that are different from each other relative to an axial direction of the connection conductor.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is a perspective view illustrating an inside of the connector according to the embodiment;

FIG. 3 is a front view illustrating the inside of the connector according to the embodiment;

FIG. 4 is a side view illustrating the inside of the connector according to the embodiment;

FIG. 5 is a perspective view illustrating a connection conductor according to the embodiment;

FIG. 6 is a perspective view explaining a process of joining a terminal to the connection conductor;

FIG. 7 is a perspective view illustrating a terminal connection structure according to the embodiment;

FIG. 8 is a cross-sectional view of a first terminal that has been joined to the connection conductor;

FIG. 9 is a cross-sectional view of a second terminal that has been joined to the connection conductor;

FIG. 10 is a cross-sectional view of an intermediate portion of the connection conductor; and

FIG. 11 is a plan view illustrating an example of the connection conductor according to the embodiment.

### DETAILED DESCRIPTION OF THE PREFERRED EMBODIMENTS

A connector and a terminal connection method according to an embodiment of the present invention are described in detail below with reference to the drawings. Note that this embodiment is not restrictive of this invention. In addition, components in the embodiment described below include components that those skilled in the art could easily conceive of, or substantially the same components.

### Embodiment

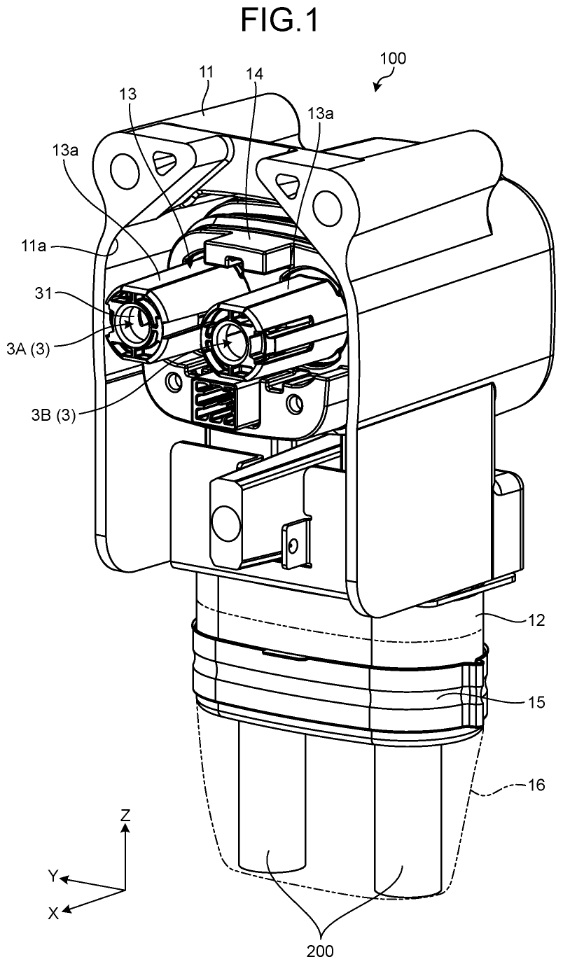

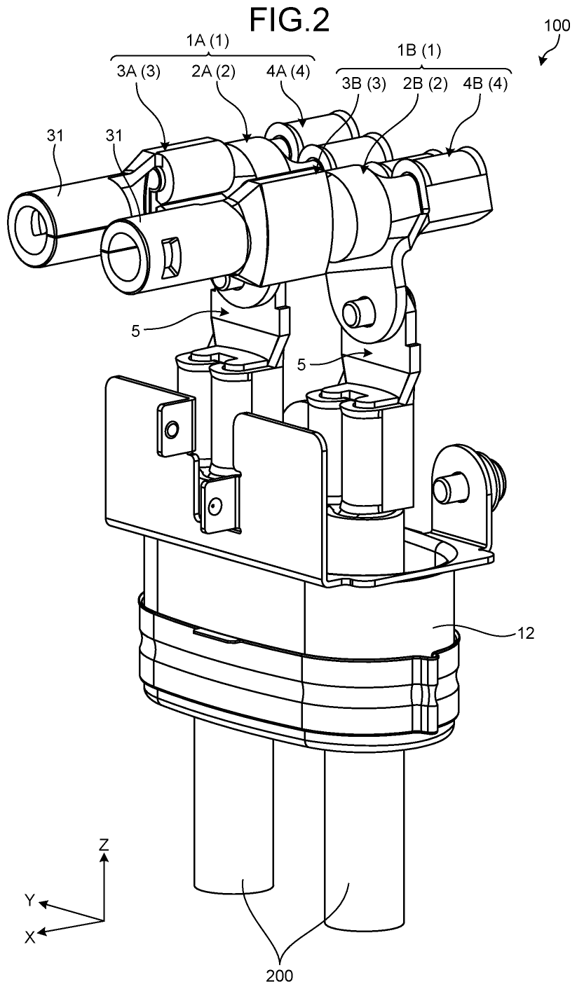

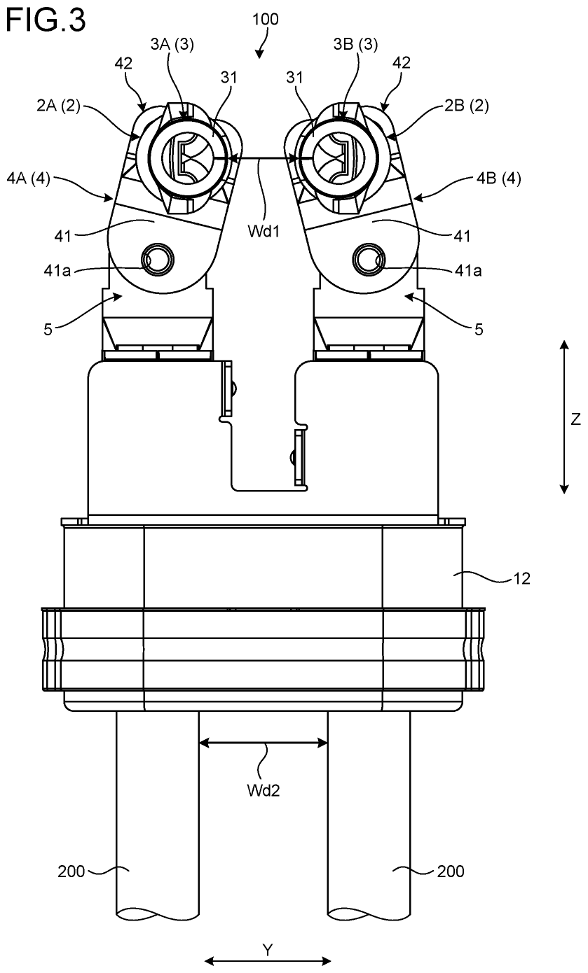

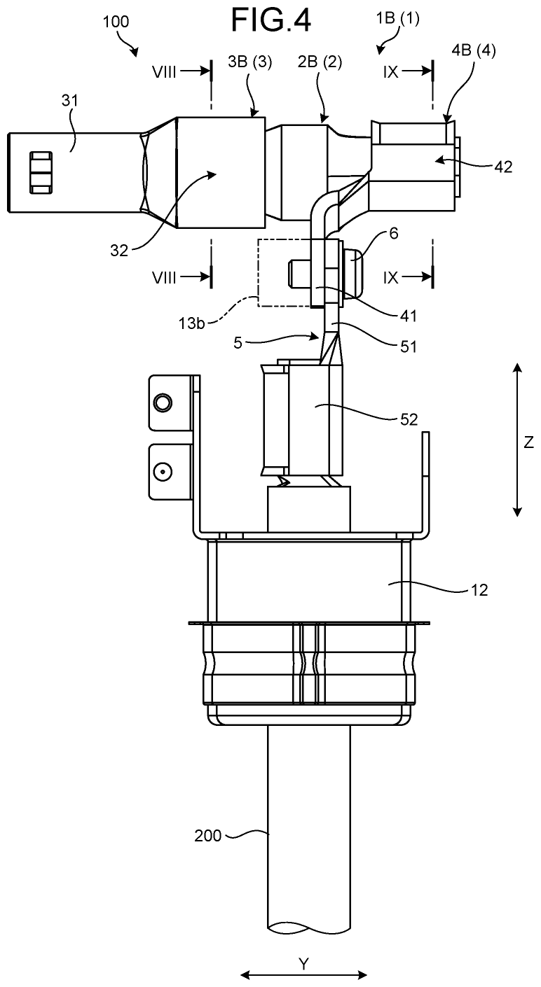

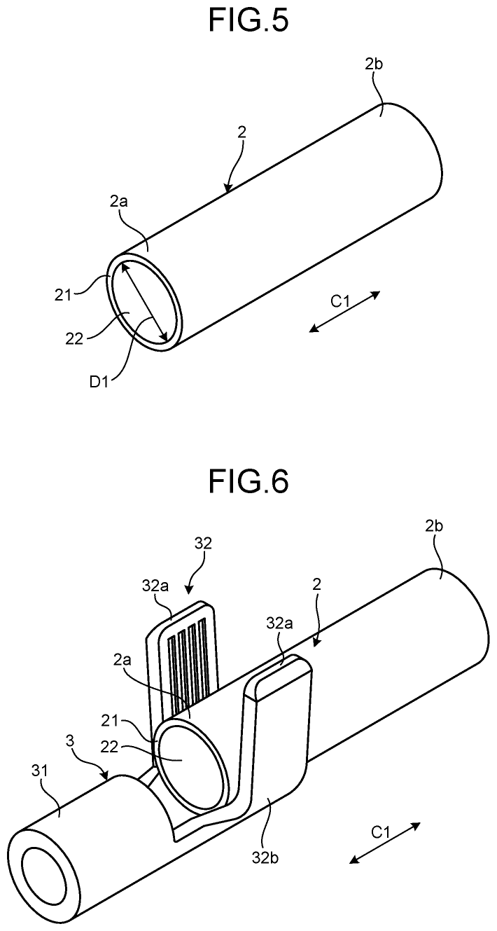

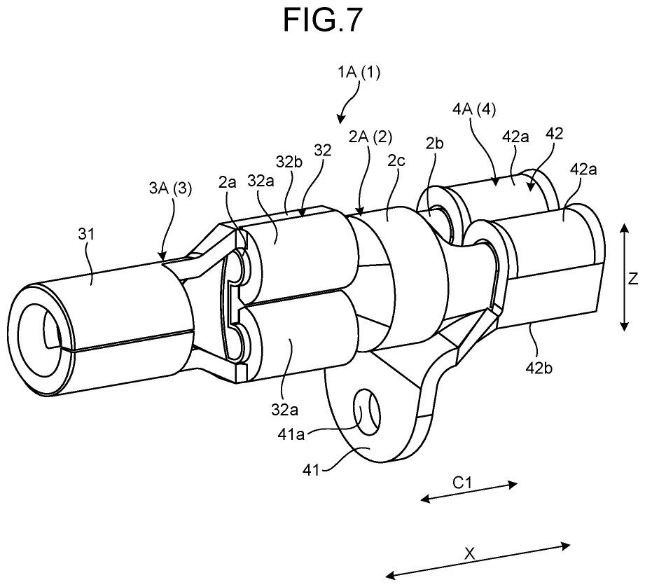

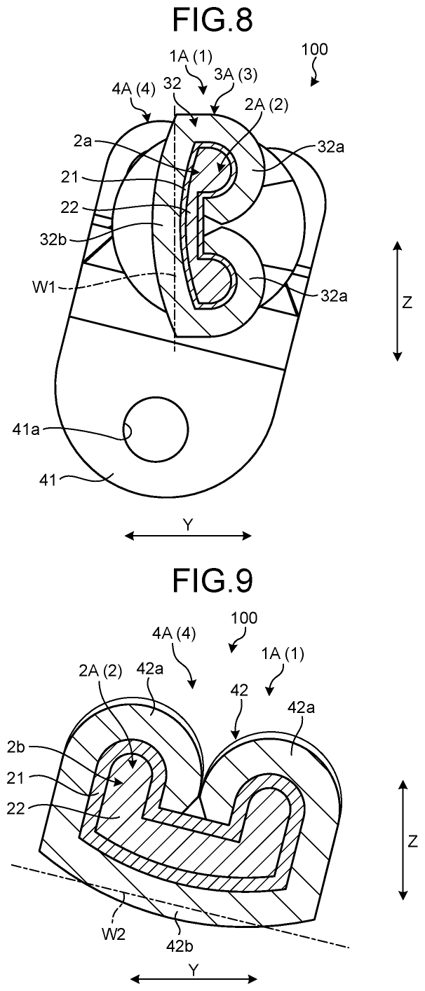

An embodiment is described with reference to FIGS. 1 to 11. The present embodiment relates to a connector and a terminal connection method. FIG. 1 is a perspective view illustrating a connector according to the embodiment, FIG. 2 is a perspective view illustrating an inside of the connector according to the embodiment, FIG. 3 is a front view illustrating the inside of the connector according to the embodiment, FIG. 4 is a side view illustrating the inside of the connector according to the embodiment, FIG. 5 is a perspective view illustrating a connection conductor according to the embodiment, FIG. 6 is a perspective view explaining a process of joining a terminal to the connection conductor, FIG. 7 is a perspective view illustrating a terminal connection structure according to the embodiment, FIG. 8 is a cross-sectional view of a first terminal that has been joined to the connection conductor, FIG. 9 is a cross-sectional view of a second terminal that has been joined to the connection conductor, and FIG. 10 is a cross-sectional view of an intermediate portion of the connection conductor.

FIG. 8 illustrates cross section VIII-VIII of FIG. 4. FIG. 9 illustrates cross section IX-IX of FIG. 4.

As illustrated in FIG. 1, a connector 100 according to the present embodiment includes a first terminal 3, a first shell 11, a second shell 12, a housing 13, a front holder 14, and a shielding ring 15. The illustrated connector 100 is a shielding connector, and shields noise by using the first shell 11 and the second shell 12. Furthermore, in the connector 100, a shielding member 16 is grounded to a casing of counterpart equipment by using the second shell 12 and the first shell 11.

The connector 100 is mounted on, for example, a vehicle such as an automobile. An example of the vehicle on which the connector 100 is mounted is an electric vehicle (EV), a hybrid electric vehicle (HEV), or a plug-in hybrid electric vehicle (PHEV). The counterpart equipment that the connector 100 is connected to may be an inverter. An electric wire 200 described later may be connected to a battery mounted on the vehicle.

The connector 100 engages with the counterpart equipment in a first direction X. The connector 100 according to the present embodiment includes two first terminals 3. The illustrated first terminals 3 are female terminals, and include a connection portion 31 having a cylindrical shape. The connection portion 31 extends in the first direction X. A male terminal included in the counterpart equipment is inserted into the connection portion 31 in the first direction X, and is electrically connected to the connection portion 31. The connector 100 electrically connects the male terminal and the electric wire 200 by using a terminal connection structure 1 and a third terminal 5 that are illustrated in FIGS. 2 to 4.

The housing 13 illustrated in FIG. 1 retains the first terminals 3, and also retains the second terminals 4 and the third terminals 5 described later. The housing 13 is molded by using, for example, an insulating synthetic resin. The housing 13 includes two tubes 13a that protrude toward a front face side in the first direction X. In a single tube 13a, a single connection portion 31 is housed. The two tubes 13a are arranged in a second direction Y. The second direction Y is a direction that is orthogonal to the first direction X, and is a width direction of the connector 100. A back face of the housing 13 is closed by an insulating cover.

The first shell 11 and the second shell 12 constitute a shielding shell that covers the housing 13. The first shell 11 and the second shell 12 are formed of a material having conductivity, such as metal. The first shell 11 is fixed to the casing of the counterpart equipment, and is electrically connected to this casing. The first shell 11 includes an opening 11a that is open to the counterpart equipment. The connection portions 31 and the tubes 13a protrude from the opening 11a toward the front face side in the first direction X.

The second shell 12 protrudes from the first shell 11 in a third direction Z. The third direction Z is a direction that is orthogonal to both the first direction X and the second direction Y, and is a height direction of the connector 100. The electric wires 200 are led out from the second shell 12 in the third direction Z. The shielding member 16 covers the electric wires 200. The shielding member 16 is, for example, a braided wire that is formed of a material having conductivity, such as metal. The shielding member 16 is swaged to the second shell 12 by using the shielding ring 15. The connector 100 according to the present embodiment is connected to two electric wires 200. The two electric wires 200 are arranged in the second direction Y.

As illustrated in FIGS. 2 to 4, the connector 100 according to the present embodiment includes the terminal connection structure 1. The terminal connection structure 1 is housed inside the housing 13. The terminal connection structure 1 includes a connection conductor 2, the first terminal 3, and the second terminal 4. As described above, the first terminal 3 is a terminal that is connected to the counterpart equipment. The second terminal 4 is electrically connected to the first terminal 3 via the connection conductor 2. The second terminal 4 is electrically connected to the electric wire 200 via the third terminal 5.

In the description below, in a case where the two first terminals 3 included in the connector 100 are distinguished from each other, one is referred to as a “first terminal 3A”, and the other is referred to as a “first terminal 3B”. Furthermore, the connection conductor 2 and the second terminal 4 that correspond to the first terminal 3A are referred to as a “connection conductor 2A” and a “second terminal 4A”, and the connection conductor 2 and the second terminal 4 that correspond to the first terminal 3B are referred to as a “connection conductor 2B” and a “second terminal 4B”. Furthermore, the terminal connection structure 1 including the first terminal 3A, the connection conductor 2A, and the second terminal 4A is referred to as a “terminal connection structure 1A”, and the terminal connection structure 1 including the first terminal 3B, the connection conductor 2B, and the second terminal 4B is referred to as a “terminal connection structure 1B”. Each of the two terminal connection structures 1A and 1B extends in the first direction X. Furthermore, the two terminal connection structures 1A and 1B face each other in the second direction Y.

FIG. 5 illustrates the connection conductor 2 before joining. The connection conductor 2 includes a braided wire 21 that has been braided in a tubular shape, and a conductor 22 that has been inserted into the braided wire 21. The braided wire 21 is formed by braiding a plurality of wires having conductivity. The wire of the braided wire 21 is, for example, a metal wire such as a copper wire. The braided wire 21 is constituted by wires having a small diameter such that the braided wire 21 has flexibility.

The illustrated conductor 22 has a columnar shape. The conductor 22 is, for example, a stranded wire that is constituted by a plurality of wires. The wire of the conductor 22 is, for example, a metal wire having conductivity, such as a copper wire. The conductor 22 is constituted by wires having a small diameter such that the conductor 22 has flexibility. The connection conductor 2 includes a first end 2a and a second end 2b. The first end 2a is an end on one side in an axial direction C1 of the connection conductor 2, and the second end 2b is an end on the other side in the axial direction C1 of the connection conductor 2. The connection conductor 2 according to the present embodiment is housed in the housing 13 in such a way that the axial direction C1 is along the first direction X. The conductor 22 extends from the first end 2a to the second end 2b. In other words, inside the braided wire 21, the conductor 22 is housed from one end to the other end in the axial direction C1.

A diameter D1 of the conductor 22 is determined, for example, in such a way that the braided wire 21 has a cylindrical shape. As an example, the conductor 22 may expand the braided wire 21 outward in a radial direction in a state where the conductor 22 has been inserted into the braided wire 21. The conductor 22 does not always need to be fixed to the braided wire 21. In other words, the conductor 22 may be housed in the braided wire 21 in a state where the conductor 22 is movable relative to the braided wire 21 in the axial direction.

A process of joining the first terminal 3 to the connection conductor 2 is described with reference to FIG. 6. The first terminal 3 is joined to the first end 2a of the connection conductor 2. The connection conductor 2 before joining includes the first end 2a and the second end 2b that have a circular cross-sectional shape. Each of the first end 2a and the second end 2b includes the braided wire 21 that has been braided in a tubular shape, and the conductor 22 that has been inserted into the braided wire 21, and has a columnar shape.

The illustrated first terminal 3 includes a swaged portion 32 that is swaged to the connection conductor 2.

The swaged portion 32 is continuous to one end of the connection portion 31, and protrudes in an axial direction of the connection portion 31. The swaged portion 32 has a roughly U-shape, and includes a pair of swaged pieces 32a and 32a, and a bottom wall 32b. The first end 2a of the connection conductor 2 is placed on the bottom wall 32b. The swaged portion 32 is swaged to the connection conductor 2 in the form of what is called B-crimp, and is joined to the first end 2a. The swaged portion 32 is crimped to the connection conductor 2 by using, for example, a terminal crimping device including a crimper and an anvil.

FIGS. 7 and 8 illustrate the first terminal 3 that has been crimped to the connection conductor 2. The first terminal 3 is joined to the connection conductor 2 in such a way that the axial direction of the connection portion 31 matches the axial direction of the connection conductor 2. As illustrated in FIG. 8, the swaged portion 32 of the first terminal 3 has been swaged in such a way that a cross-sectional shape is a B-shape. The swaged pieces 32a have been crimped to the connection conductor 2 while directing distal ends of the swaged pieces 32a to the bottom wall 32b. The first end 2a of the connection conductor 2 has been transformed in such a way that a cross-sectional shape is a roughly B-shape. The braided wire 21 covers the whole circumference of the conductor 22 to protect the conductor 22. As illustrated in FIG. 7, the second terminal 4 is joined to the second end 2b of the connection conductor 2.

The illustrated second terminal 4 is crimped to the connection conductor 2. The second terminal 4 includes a connection portion 41 and a swaged portion 42. The connection portion 41 has a flat plate shape, and includes a through-hole 41a. The swaged portion 42 includes a pair of swaged pieces 42a and 42a, and a bottom wall 42b. The second terminal 4 is joined to the connection conductor 2 in such a way that an axial direction of the swaged portion 42 matches the axial direction of the connection conductor 2. As illustrated in FIG. 9, the swaged portion 42 of the second terminal 4 is crimped to the connection conductor 2 in the form of what is called B-crimp. The swaged portion 42 is crimped to the second end 2b by using, for example, a terminal crimping device. The swaged pieces 42a have been crimped to the connection conductor 2 while directing distal ends of the swaged pieces 42a to the bottom wall 42b. The second end 2b of the connection conductor 2 has been transformed in such a way that a cross-sectional shape is a roughly B-shape. The braided wire 21 covers the whole circumference of the conductor 22 to protect the conductor 22.

As illustrated in FIG. 7, in the second terminal 4, the connection portion 41 is orthogonal to the axial direction of the swaged portion 42. In other words, the second terminal 4 is bent between the connection portion 41 and the swaged portion 42 to form an L-shape. The connection portion 41 protrudes from the swaged portion 42, for example, in a direction that is orthogonal to the first direction X. As illustrated in FIGS. 7 and 8, the first terminal 3 and the second terminal 4 have been joined in rotation positions different from each other relative to the axial direction of the connection conductor 2. Here, the rotation positions of the first terminal 3 and the second terminal 4 are rotation positions relative to the axial direction C1 of the connection conductor 2. Stated another way, the rotation positions of the first terminal 3 and the second terminal 4 are positions in a rotation direction relative to a center axial line of the connection conductor 2. As illustrated in FIG. 8, the first terminal 3 has been joined to the connection conductor 2 in such a way that a width direction W1 of the bottom wall 32b is along the third direction Z. In the illustrated connector 100, the width direction W1 matches the third direction Z. As illustrated in FIG. 9, the second terminal 4 has been joined to the connection conductor 2 in such a way that a width direction W2 of the bottom wall 42b is inclined relative to the second direction Y. In the illustrated connector 100, the width direction W2 is inclined relative to both the second direction Y and the third direction Z.

By inclining the bottom walls 42b of the second terminals 4, as described above, an interval Wd1 between the connection portions 31 can be reduced, as illustrated in FIG. 3. The connection portions 41 of the second terminals 4 are inclined relative to the third direction Z in such a way that the connection portions 41 become closer to each other in a portion closer to the swaged portion 42 from the through-hole 41a. By inclining the second terminals 4, the connector 100 can be reduced in size. For example, the housing 13 can be reduced in size in the second direction Y and the third direction Z. Furthermore, by inclining the second terminals 4, the interval Wd1 between the connection portions 31 is easily adjusted to a desired value. For example, the interval Wd1 between the connection portions 31 can be freely set relative to an interval Wd2 between the electric wires 200.

In the present embodiment, the connection conductor 2 before joining has a columnar shape. Accordingly, the rotation position of the second terminal 4 relative to the connection conductor 2 is not affected by the rotation position of the first terminal 3 relative to the connection conductor 2. In other words, the width direction W2 of the second terminal 4 can be arbitrarily set relative to the width direction W1 of the first terminal 3. As a comparative example, a connection conductor that does not include the conductor 22, and is constituted by a braided wire is examined. In the connection conductor in the comparative example, the braided wire is hollow, and therefore the braided wire has a flat cross-sectional shape. Stated another way, the connection conductor before joining has a flat shape. Therefore, the rotation positions of the first terminal 3 and the second terminal 4 relative to the connection conductor are restricted by a shape of the connection conductor. For example, the width direction W1 of the first terminal 3 needs to be aligned with the width direction W2 of the second terminal 4.

In contrast, the connection conductor 2 according to the present embodiment has a cylindrical shape before joining. Therefore, the rotation positions of the first terminal 3 and the second terminal 4 relative to the connection conductor 2 can be arbitrarily selected. In other words, a phase of the first terminal 3 and a phase of the second terminal 4 can be arbitrarily set relative to the axial direction C1 of the connection conductor 2. This results in improvements in a degree of freedom of disposition of each part in the connector 100.

As illustrated in FIG. 4, the connection portion 41 of the second terminal 4 is connected to the third terminal 5. The third terminal 5 is a terminal that is connected to the electric wire 200, and extends in the third direction Z. The third terminal 5 includes a connection portion 51 and a swaged portion 52. The swaged portion 52 is crimped to a core wire of the electric wire 200. The connection portion 41 of the second terminal 4 and the connection portion 51 of the third terminal 5 are fastened by a bolt 6. More specifically, the bolt 6 is inserted into a through-hole of the connection portion 51 and the through-hole 41a of the connection portion 41, and is screwed into a nut 13b. The nut 13b is retained by the housing 13. Stated another way, the second terminal 4 and the third terminal 5 are fixed to the housing 13 by the bolt 6.

As illustrated in FIG. 7, the connection conductor 2 after joining includes an intermediate portion 2c having a cylindrical shape. The intermediate portion 2c is a portion between the first end 2a and the second end 2b. In other words, the intermediate portion 2c is a portion between the first terminal 3 and the second terminal 4. As illustrated in FIG. 10, the intermediate portion 2c has a circular cross-sectional shape. The braided wire 21 has a cylindrical shape that covers an outer circumferential surface of the conductor 22. The braided wire 21 is formed by braiding a plurality of wires 21e. The conductor 22 is formed by bundling a plurality of wires 22e. A diameter E1 of the wire 21e may be equal to a diameter E2 of the wire 22e. For example, the diameters E1 and E2 may be determined in such a way that both the braided wire 21 and the conductor 22 have appropriate flexibility. As an example, the diameters E1 and E2 may be 0.12 [mm]. In the terminal connection structure 1 according to the present embodiment, each of the braided wire 21 and the conductor 22 can be freely transformed between the first terminal 3 and the second terminal 4. Stated another way, the braided wire 21 does not regulate transformation of the conductor 22, and the conductor 22 does not regulate transformation of the braided wire 21. Therefore, the connection conductor 2 can have sufficient flexibility between the first terminal 3 and the second terminal 4.

Note that the diameter E1 of the wire 21e may be larger than the diameter E2 of the wire 22e. In this case, the diameter E1 of the wire 21e of the braided wire 21 may be set to be large enough to prevent the wire 22e from being cut at the time of crimping. The wire 21e that is relatively thick covers the wire 22e of the conductor 22, and can protect the wire 22e. The wire 21e of the braided wire 21 is interposed between the swaged portion 32 or 42 and the wire 22e, and this can prevent the wire 22e from being excessively transformed. Therefore, the braided wire 21 can prevent the wire 22e of the conductor 22 from being broken.

The braided wire 21 protects the conductor 22, and therefore the diameter E2 of the wire 22e of the conductor 22 can be reduced in size. Therefore, in the connection conductor 2, both securing flexibility and preventing wire from being cut are achieved. The diameter E2 of the wire 22e of the conductor 22 may be, for example, 0.05 [mm]. The diameter E1 of the wire 21e of the braided wire 21 may be, for example, 0.12 [mm] or 0.32 [mm].

As described above, the connection conductor 2 according to the present embodiment includes the braided wire 21 that has been braided in a tubular shape, and the conductor 22 that has been inserted into the braided wire 21, and has a columnar shape. The braided wire 21 and the conductor 22 constitute the first end 2a and the second end 2b that are to be joined to the first terminal 3 and the second terminal 4. In the connection conductor 2 according to the present embodiment, the rotation position of the first terminal 3 and the rotation position of the second terminal 4 relative to the connection conductor 2 can be arbitrarily set. Stated another way, the connection conductor 2 according to the present embodiment enables the first terminal 3 and the second terminal 4 to be joined to the connection conductor 2 in arbitrarily rotation positions.

The connection conductor 2 according to the present embodiment is a stranded wire having a columnar shape, and extends from one end to another end of the braided wire 21. Therefore, a sufficient cross-sectional area for energization can be secured from one end to another end of the connection conductor 2.

The terminal connection structure 1 according to the present embodiment includes the connection conductor 2, the first terminal 3 that has been joined to the first end 2a of the connection conductor 2, and the second terminal 4 that has been joined to the second end 2b of the connection conductor 2. The connection conductor 2 includes the braided wire 21 that has been braided in a tubular shape, and the conductor 22 that has been inserted into the braided wire 21. The conductor 22 extends from the first end 2a to the second end 2b. In the conductor 22, the intermediate portion 2c between the first end 2a and the second end 2b has a columnar shape. A rotation position of the first terminal 3 and a rotation position of the second terminal 4 relative to the axial direction of the connection conductor 2 are different from each other. The terminal connection structure 1, as described above, can be easily implemented by the connection conductor 2 in which each of the first end 2a and the second end 2b before joining has a circular cross-sectional shape. Therefore, the first terminal 3 and the second terminal 4 have arbitrary rotation positions relative to the connection conductor 2.

A terminal connection method according to the present embodiment includes a process of joining the first terminal 3 to the first end 2a of the connection conductor 2, and a process of joining the second terminal 4 to the second end 2b of the connection conductor 2. The first end 2a and the second end 2b before joining include the braided wire 21 that has been braided in a tubular shape, and the conductor 22 that has been inserted into the braided wire 21, and has a columnar shape. The first terminal 3 and the second terminal 4 are joined to the connection conductor 2 in rotation positions different from each other relative to the axial direction of the connection conductor 2. By employing the terminal connection method according to the present embodiment, two terminals 3 and 4 can be joined to the connection conductor 2 in arbitrary rotation positions.

Note that the conductor 22 that is inserted into the braided wire 21 is not limited to a stranded wire. The conductor 22 may be, for example, a round bar having conductivity, may be a braided wire that is different from the braided wire 21, or may be another conductor.

The conductor 22 may have a cylindrical shape. As an example, the conductor 22 may be a hollow stranded wire, or may be a tube that is made of metal, and is formed into a cylindrical shape. A core may be disposed in the center of the conductor 22. The core does not always need to have conductivity. A material of the core may have flexibility that is higher than flexibility of a material of the conductor 22.

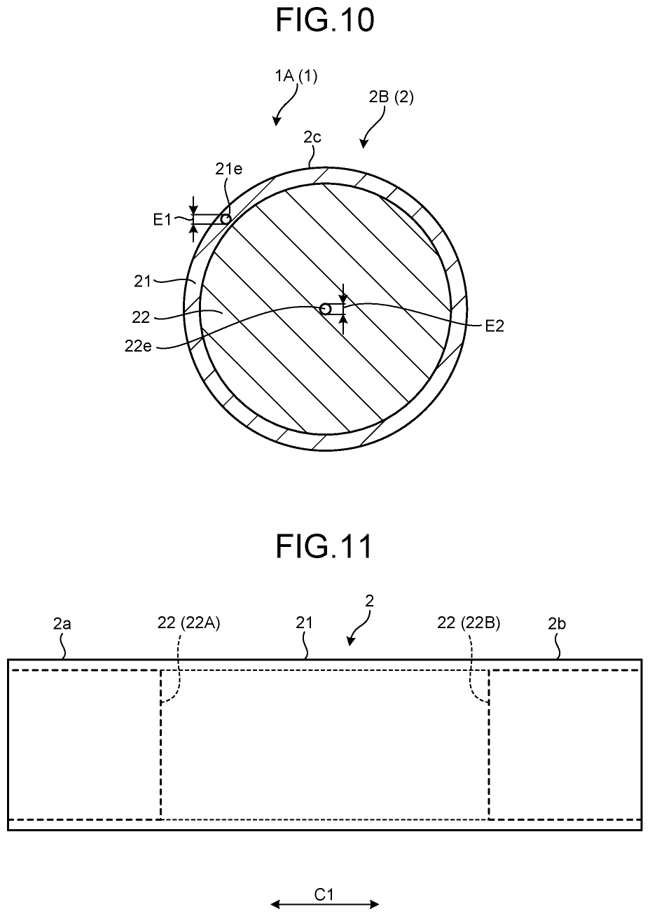

As illustrated in FIG. 11, in the connection conductor 2, the conductor 22 does not always need to be disposed between the first end 2a and the second end 2b. In this case, the conductor 22 includes a first conductor 22A that is disposed at the first end 2a, and a second conductor 22B that is disposed at the second end 2b. The first conductor 22A and the second conductor 22B may be fixed to the braided wire 21 by performing adhesion or the like.

A form of crimping the first terminal 3 and the second terminal 4 to the connection conductor 2 is not limited to B-crimp. A method for joining the first terminal 3 and the second terminal 4 to the connection conductor 2 is not limited to crimping. The first terminal 3 and the second terminal 4 may be joined to the connection conductor 2 by performing, for example, ultrasonic joining. The braided wire 21 protects the conductor 22, and can prevent the wire 22e from being cut at the time of vibration.

The connection conductor 2 may be bent between the first terminal 3 and the second terminal 4. For example, the connection conductor 2 may be bent into an L-shape in the intermediate portion 2c. In this case, the second terminal 4 may be joined to the core wire of the electric wire 200. For example, the second terminal 4 may include a swaged portion that is crimped to the electric wire 200, instead of the connection portion 41.

Note that cross-sectional shapes of the first end 2a and the second end 2b before joining are not limited to a circular shape, as illustrated. The cross-sectional shapes of the first end 2a and the second end 2b are appropriately determined in such a way that a terminal can be joined in an arbitrary rotation position. Before performing a joining process on the terminals, a forming process for shaping the first end 2a and the second end 2b may be performed.

Pieces of content disclosed in the embodiment described above can be appropriately combined and implemented.

A connector and a terminal connection method according to the present embodiment exhibit an advantageous effect in which a terminal can be positioned in an arbitrary rotation position relative to a connection conductor, and the terminal can be joined to the connection conductor.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
connection conductors that include a braided wire that has been braided in a tubular shape, and a conductor that has been inserted into the braided wire, and extend in the first direction;
first terminals that have been joined to a first end of each of the connection conductors, and include connection portion connected to a counterpart terminal;
second terminals that have been joined to a second end of each of the connection conductors, and connected to electric wires; and
a housing that retains the first terminals and second terminals, wherein
two of the connection conductors are arranged in a second direction that is orthogonal to the first direction, two of the first terminals are arranged in the second direction, and two of the second terminals are arranged in the second direction,
the conductor extends from the first end to the second end,
in the conductor, a portion between the first end and the second end has a columnar shape or a cylindrical shape, and
a rotation position of the first terminal and the rotation position of the second terminal relative to an axial direction of the connection conductor are different from each other in such a way that an interval between the connection portions in the second direction relative to an interval between the electric wires in the second direction is small.

2. The connector according to claim 1, further comprising:
third terminals that have been joined to the electric wires, wherein
the second terminal is connected to the electric wire via the third terminal, and
the second terminal and the third terminal are fastened to the housing by a bolt.

3. The connector according to claim 2, wherein
the electric wire is led out in a third direction that is orthogonal to both the first direction and the second direction,
the second terminal includes a second connection portion that is connected to the third terminal, and a swaged portion that is joined to the connection conductor,
the second terminal is joined to the connection conductor in such a way that an axial direction of the swaged portion matches the axial direction of the connection conductor, and
the second connection portion is orthogonal to the axial direction of the swaged portion, and inclined relative to the third direction.

4. A terminal connection method comprising:
a process of joining a first terminal to a first end of a connection conductor; and
a process of joining a second terminal to a second end of the connection conductor, wherein
the first end and the second end before joining include a braided wire that has been braided in a tubular shape and a conductor that has been inserted into the braided wire, the conductor having a columnar shape or a cylindrical shape, and
the first terminal and the second terminal are joined to the connection conductor in rotation positions that are different from each other relative to an axial direction of the connection conductor.
